(19) United States
(12) Patent Application Publication
(10) Pub. No.: US 2018/0061012 A1
(43) Pub. Date: Mar. 1, 2018

(54) APPARATUS AND METHODS FOR VIDEO IMAGE POST-PROCESSING FOR CORRECTING ARTIFACTS

(71) Applicant: GOPRO, INC., CARLSBAD, CA (US)

(72) Inventors: AARON STARANOWICZ, CARLSBAD, CA (US); RYAN LUSTIG, ENCINITAS, CA (US); BALINEEDU CHOWDARY ADSUMILLI, SAN FRANCISCO, CA (US)

(21) Appl. No.: 15/251,896

(22) Filed: Aug. 30, 2016

(51) Int. Cl. G06T 5/00; G06T 3/40

(52) U.S. Cl. CPC G06T 5/002; G06T 5/003; G06T 3/4007

(57) ABSTRACT

Apparatus and methods for video image post-processing for correcting, e.g., spatial and/or temporal artifacts. Embodiments described herein obtain frames of video data from a native source and perform super resolution on these captured frames of video data in order to increase the size of these frames. Forward and backward pixel motion calculations are then performed on these calculated super resolution frames. Additionally, superpixel calculations are performed on various objects contained within these super resolution frames and occlusion masks are generated. Interpolated frames of data are then generated by taking into consideration, for example, these generated occlusion masks and the super resolution interpolated frames of data are down sampled back down to their original size.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the Disclosure

The present disclosure relates generally to video image post-processing and in one exemplary aspect, to methods and apparatus for generating interpolated frames of data utilizing super resolution and superpixel image processing techniques.

### Description of Related Art

Frame interpolation is a common post-processing technology that enables, for example, modern display devices to increase the perceived framerate of natively captured video data. In addition, frame interpolation techniques enable the ability to take into account the motion of pixels on the frames of video data by analyzing the spatial relationship between pixels in the initial and subsequent frame(s). However, in the interpolation phase, each pixel in the interpolated frame is assumed to be a separate entity, thereby resulting in spatial and temporal artifacts in the interpolated video data.

These spatial and temporal artifacts include degradation artifacts in the image such as blurring, and non-smooth and/or non-sharp images. Additionally, objects within these interpolated video frames can become distorted or warped by, for example, lines becoming waves, connected objects becoming disconnected, and non-smooth object motion. Accordingly, techniques are needed to improve upon these frame interpolation techniques, and minimize or eliminate these spatial and temporal artifacts in order to allow, for example, modern display devices to perform to their capabilities when displaying video content that was natively captured at lesser frame rates.

### SUMMARY

The present disclosure satisfies the foregoing needs by providing, inter alia, methods and apparatus for minimizing or eliminating one or more spatial and/or temporal artifacts associated with the generation of interpolated video data.

In a first aspect of the present disclosure, an apparatus configured to generate interpolated frames of video data is disclosed. In one embodiment, the apparatus includes a video data interface configured to receive a plurality of frames of video data, each of the frames of video data having a native resolution; a processing apparatus in data communication with the video data interface; and a storage apparatus having a non-transitory computer readable medium comprising a plurality of instructions. In one variant, the plurality of instructions are configured to, when executed by the processing apparatus, cause the apparatus to: receive an initial and subsequent frame of video data from the received plurality of frames of video data; perform a super resolution calculation on the initial and subsequent frames of video data in order to produce at least a super resolution initial frame and a super resolution subsequent frame; perform a superpixel calculation on at least the super resolution initial frame and the super resolution subsequent frame; generate an interpolated super resolution frame of data; and downsample the interpolated super resolution frame of data back to the native resolution in order to generate an interpolated frame of data.

In one implementation, the plurality of instructions are further configured to generate an occlusion mask based at least in part on the performed superpixel calculation; generate the interpolated super resolution frame of data based at least in part on the generated occlusion mask.

In a second aspect of the present disclosure, a method of generating interpolated frames of video data is disclosed. In one embodiment, the method includes causing the performance of a super resolution calculation on at least initial and subsequent frames of video data in order to produce a super resolution initial frame and a super resolution subsequent frame; causing the performance of a superpixel calculation on the super resolution initial frame and the super resolution subsequent frame; causing the generation of an interpolated super resolution frame of data (based, for example, at least in part on a generated occlusion mask); and causing the downsampling of the interpolated super resolution frame of data back to a native resolution in order to generate an interpolated frame of data.

In another aspect of the present disclosure, a computing device is disclosed. In one embodiment, the computing device includes computerized logic configured to: receive an initial and subsequent frame of video data from a plurality of captured frames of video data; perform a super resolution calculation on the initial and subsequent frames of video data in order to produce a super resolution initial frame and a super resolution subsequent frame; generate an interpolated super resolution frame of data; and downsample the interpolated super resolution frame of data back to a native resolution in order to generate an interpolated frame of data.

In one implementation, an occlusion mask is generated based at least in part on a performed superpixel calculation, and the interpolated super resolution frame of data is generated based at least on the occlusion mask.

In a further aspect of the present disclosure, a method of performing a super resolution calculation is disclosed. In one embodiment, the method includes: receiving a plurality of frames of video data including an initial frame and a subsequent frame; generating a super resolution initial frame using the initial frame and one or more preceding frames; and generating a super resolution subsequent frame using the subsequent frame and an adjacent frame, the adjacent frame occurring after the subsequent frame.

In yet another aspect of the present disclosure, a method of performing a super pixel calculation is disclosed. In one embodiment, the method includes receiving a plurality of frames of video data including an initial frame and a subsequent frame; performing a super pixel calculation on both the initial frame and the subsequent frame; generating one or more occlusion masks subsequent to the super pixel calculation; and generating an interpolated frame of video data based at least in part on the one or more occlusion masks.

In still a further aspect of the present disclosure, a computer readable storage medium is disclosed. In one embodiment, the computer readable storage medium includes one or more instructions, that when executed by a processing apparatus, are configured to: receive an initial and subsequent frame of video data from a received plurality of frames of video data; perform a super resolution calculation on the initial and subsequent frames of video data in order to produce a super resolution initial frame and a super resolution subsequent frame; perform a superpixel calculation on the super resolution initial frame and the super resolution subsequent frame; generate an occlusion mask based at least in part on the performed superpixel calculation; generate an interpolated super resolution frame of data based at least in part on the generated occlusion mask; and downsample the interpolated super resolution frame of data back to the native resolution in order to generate an interpolated frame of data.

In another aspect of the disclosure, an integrated circuit (IC) apparatus is disclosed. In one embodiment, the IC apparatus comprises one or more silicon-based integrated circuit devices configured to perform the post-processing methodologies described herein in a power-efficient and thermally efficient manner.

Other features and advantages of the present disclosure will immediately be recognized by persons of ordinary skill in the art with reference to the attached drawings and detailed description of exemplary implementations as given below.

### BRIEF DESCRIPTION OF THE DRAWINGS

FIG. 1 is a logical flow diagram of one exemplary method for generating interpolated frames of data, according to the present disclosure.

FIG. 2A is a graphical representation of two exemplary frames of video data, useful in conjunction with the principles described herein.

FIG. 2B is graphical representation of an exemplary interpolated frame of video data using the two frames of data shown in FIG. 2A, useful in conjunction with the principles described herein.

FIG. 3 is a logical flow diagram of another exemplary method for generating interpolated frames of data, according to the present disclosure.

FIG. 4 is graphical representation of an exemplary series of frames of video data, useful in conjunction with the principles described herein.

FIG. 5 is a block diagram of an exemplary implementation of a computing device, useful in performing the methodologies described herein.

All Figures disclosed herein are © Copyright 2016 GoPro, Inc. All rights reserved.

### DETAILED DESCRIPTION

Implementations of the present technology will now be described in detail with reference to the drawings, which are provided as illustrative examples and species of broader genuses so as to enable those skilled in the art to practice the technology. Notably, the figures and examples below are not meant to limit the scope of the present disclosure to any single implementation or implementation, but other implementations are possible by way of interchange of, substitution of, or combination with some or all of the described or illustrated elements. Wherever convenient, the same reference numbers will be used throughout the drawings to refer to same or like parts.

Moreover, while implementations described herein are primarily discussed in the context of non-stitched/non-panoramic video content, it is readily appreciated that the principles described herein can be equally applied to other source video content including for instance the aforementioned stitched/panoramic video content. For example, when obtaining panoramic (e.g., 360°) content, two or more images may be combined. In some implementations, six or more source images may be combined (stitched together along one or more boundaries between the images) to obtain an image with a desired field of view or FOV (e.g., 360°). It is readily appreciated by one of ordinary skill given this disclosure that the interpolation and other methods and apparatus described herein for reducing the appearance of, inter alia, temporal and/or spatial artifacts may be readily applied or adapted to these panoramic/stitched images.

### Methods—

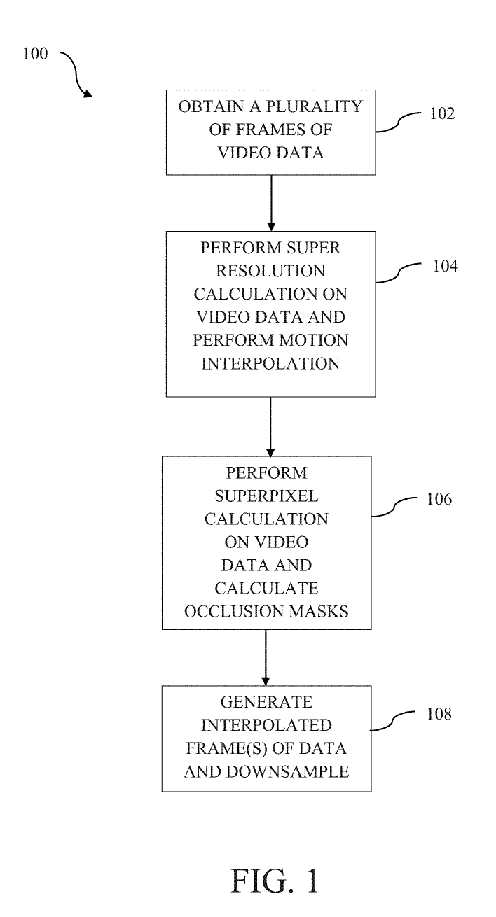

Referring now to FIG. 1, one exemplary generalized method 100 for generating interpolated frames of video data is shown. At step 102 of the method 100, multiple frames of video data are obtained. Obtaining the images may be made from retrieving previously captured frames of image data via an extant source (e.g., storage device), or directly (or indirectly) using an image capture device such as, for example, via the HERO family of digital video cameras offered by the assignee hereof. These frames of video data may be obtained at a variety of differing display resolutions (e.g., standard-definition, enhanced-definition, high-definition and ultra-high-definition) and within each of these differing display resolutions, these images may be obtained at a variety of differing frame rates (e.g., twenty-four (24) frames per second, twenty-five (25) frames per second, thirty (30) frames per second, sixty (60) frames per second, one-hundred twenty (120) frames per second, two-hundred forty (240) frames per second and/or other frame rates).

As used herein, the designation ‘t’ indicates discrete steps or coordinates in time in which frames of data are obtained or captured. For example, where the image capture device obtains sixty (60) frames of data per second, there would be sixty (60) discrete instances of ‘t’ for every second of data taken. In other words, when capturing one second's worth of video data using for example, an image capturing device that obtains sixty (60) frames of data per second, the second's worth of data will result in a series of images that run from frame t to frame t+59. As yet another example, where the image capture device obtains two-hundred forty (240) frames of data per second, there would be two-hundred forty (240) discrete instances of ‘t’ for every second of data taken (i.e., the series of images captured in a second of time would run from frame t to frame t+239).

At step 104 of the method 100, one or more super resolution calculations are performed on the video data obtained at step 102, and motion interpolation is performed on the individual pixels of the image. The use of super resolution allows for a given frame of data to be increased in size/resolution based on, for example, the surrounding frame(s) of data associated with the given frame of data. For example, using super resolution calculations, one can increase the resolution of a 720p frame to that of a 1080p frame based on information contained within, for example, the surrounding frame(s) of data. In addition to performing super resolution calculations on the initial frame, an adjacent frame of data (i.e., adjacent to the initial frame of data) is also increased in size based on the surrounding frame(s) of data associated with the adjacent frame of data.

As a brief aside, super resolution generally refers to operations in which one or more low-resolution images are “enhanced” resulting in the production of a high-resolution image for that captured scene. There a numerous known methodologies for performing super resolution calculations, with each of these techniques having their respective advantages/disadvantages. However, virtually all of these super resolution calculation techniques result in an increase in size (i.e., number of pixels for the resultant super resolution frame) for the spatial resolution of the captured images using multiple relatively low-resolution images that have captured the same or similar scene.

The use of super resolution calculations works best with a series of images in which various objects within a given frame of data vary in position within the adjacent frames of data, but otherwise have relatively small displacements (i.e., there perceived positional locations change location within the series of frames). Ideally, displacements for at least some of the objects within the scene will occur on the subpixel level (i.e., the relative motion of objects contained within a scene will result in displacements that are at some fraction of a width for a given pixel). Accordingly, it is recognized that performing super resolution calculations with data from image capturing devices that capture images with moving objects at a higher frame rate (e.g., two-hundred and forty (240) frames per second) tend to resolve better than image capturing devices with a lower frame rate (e.g., twenty-four (24) frames per second) when attempting to capture a similar scene.

One exemplary super resolution calculation technique includes that disclosed and described in D. Mitzel, T. Pock, T. Schoenemann, D. Cremers. Video super resolution using duality based TV-L1 optical flow. DAGM, 2009, the contents of which are incorporated herein by reference in its entirety. The super resolution techniques described therein are more robust to errors in motion and blur estimation than other super resolution techniques resulting in sharper super resolution images. It accomplishes this by, inter alia, assuming blur is space invariant and constant for all of its captured images. Regardless of the particular super resolution calculation chosen, all such super resolution techniques typically require the use of multiple frames of video data.

In one such implementation, super resolution is performed on a given frame of data t, by utilizing data from frame t−1. Accordingly, by utilizing data from frame t−1, the given frame of data t is increased in size/resolution. For example, if the given frame of data t has an image size of twelve (12) megapixels and frame t−1 has an image size of twelve (12) megapixels; super resolution frame t can result in, for example, an image size of approximately twenty-four (24) megapixels. Additionally, for an adjacent frame of data t+1, super resolution is performed on the given frame of data t+1 utilizing data from frame t+2. Accordingly, by utilizing data from frame t+2, the adjacent frame of data t+1 can also be increased in size similarly. In other words, and using the aforementioned example, the adjacent frame of super resolution data t+1 will also have been increased in image size by approximately the same amount of the frame of data t.

In one or more implementations, for a given frame of data t, super resolution is performed on the given frame of data t by utilizing data contained within frame t+1. Additionally, super resolution is performed on frame of data t+1 by utilizing data contained within frame t. Accordingly, by utilizing data from frame t and frame t+1, and vice versa, these super resolution frames of data (i.e., super resolution frame t and super resolution frame t+1) can be increased in size/resolution similarly.

In one or more implementations, for a given frame of data t, super resolution is performed on the given frame of data t by utilizing data from frame t+1 and from frame t−1. Accordingly, by utilizing data from frame t+1 and frame t−1, the resolution for the super resolution given frame of data t can generally be increased in size further than variants in which a series of two frames are utilized due to the additional information present. Ultimately, however, the user determines the super resolution frame height and frame width (e.g., two times the size, three times the size, four times the size, etc.). Additionally, for an adjacent frame of data t+1, super resolution is performed on the given frame of data t+1 utilizing data from frame t and from frame t+2, resulting in super resolution frame of data t+1.

In one or more implementations, for a given frame of data t, super resolution is performed on the given frame of data t by utilizing data from frame t−1 and from frame t−2. Accordingly, the super resolution frame t may be increased in size. Additionally, for an adjacent frame of data t+1, super resolution is performed on the given frame of data t+1 utilizing data from frame t+2 and from frame t+3. Accordingly, by utilizing data from frame t+2 and frame t+3, the adjacent frame of data t+1 can similarly be increased in size.

In addition, to utilizing information from a series of frames of data, it is possible to perform single frame super resolution calculations as well on a given frame of data. For example, using the techniques described in “Chang, Hong, Dit-Yan Yeung, and Yimin Xiong. Super-resolution through neighbor embedding. Computer Vision and Pattern Recognition, 2004. CVPR 2004. Proceedings of the 2004 IEEE Computer Society Conference on Vol. 1, IEEE, 2004”, the contents of which being incorporated herein by reference in its entirety, super resolution can be performed on a single low resolution image. However, the use of a single frame of data to perform super resolution often requires a given set of training example images which may or may not be readily available depending upon the situation surrounding the capture of video data.

These and other variations would be readily apparent to one of ordinary skill given the contents of the present disclosure. For example, in instances in which there is a relatively small displacement of objects within a series of images (e.g., due to the high frame capture rate of the image capturing device and/or the large number of pixels contained within the captured image), additional frames of data can be utilized in order to perform the super resolution calculation. The term “small displacement” refers to the size of the displacement relative to the image size/resolution. For example, an object displacement of ten (10) pixels may be quite large (e.g., a 480p image); however, ten (10) pixels of object displacement can be considered relatively small when discussed in the context of a 4K image, for example.

Additionally, the forward and backward pixel motion calculations (e.g., forward and backward optical flow calculations) are performed on the calculated super resolution frame(s) of data. These forward and backward pixel motion calculations enable, for instance, the later calculation of the interpolated frame of data at step 108. Additionally, these forward and backward pixel motion calculations can be calculated at any intermediate division of time between frames. For example, these forward and backward pixel motion calculations of time may be made at a tenth of a step (e.g., at time ‘t−0.1’), a third of a step (e.g., at time ‘t−0.33’, a half of a step (e.g., at time ‘t−0.5’) and literally any other intermediate division of time desired.

In addition to the foregoing, more than one intermediate division of time calculation may be performed for a series of captured images. These intermediate divisions of time may be calculated at constant intervals (e.g., at frame t+0.25, frame t+0.5, and frame t+0.75 as but one example) as well as at non-constant intervals (e.g., at frame t+0.5, frame t+0.6, frame t+0.75, as yet another example). These and other variants would be readily appreciated by one of ordinary skill given the contents of the present disclosure.

At step 106 of the method 100, a superpixel calculation is performed on the video data and occlusion masks are calculated. Superpixels are an image clustering technique whereby groups of pixels are clustered together so that each of these groups of pixels are treated as a single entity. For example, superpixels can be used to cluster spatially similar pixels based on similarities in the coloring of groups of pixels, the intensity of groups of pixels and/or the image gradients associated with the groups of pixels.

For example, one exemplary methodology for performing a superpixel calculation is as follows. A grid of M by N is selected by a user to be overlaid over a given frame of data. The values M and N comprise integer values and M may, or may not, be equal to the value of N. For each grid point, the value(s) (e.g., color value, intensity values, image gradient values and the like) associated with a neighboring pixel are compared against that grid points' value(s). If a match is found, then additional neighboring grids are checked to see whether or not their values match. If the pixels value(s) do not match, then that pixel is skipped with a new grid point added at that location. The process is repeated until all pixels are assigned to a given group. Accordingly, by systematically comparing pixel value(s) for a given grid point against its adjacent neighbors, various groupings (i.e., superpixels) can be created. In addition, determining whether or not a match exists can also be a factor that is selectively determined. For example, when comparing a color value between two adjacent grid points, a match can be made based on the proximity of a particular grid point's color value to the color value of an adjacent grid point. If that grid point's color value is within a threshold value, then those two grid points are combined. If that grid point's color value falls outside of the threshold value, then those two grid points will not be combined. This threshold value may be determined by a user on a per processing basis. The process is repeated for neighboring grid points until every pixel within the given frame of data has been checked.

Additionally, occlusion masks are generated and utilized to indicate if a set of pixels are being occluded within a given frame of video data. In other words, the occlusion masks are utilized in order to tell whether or not a pixel has a forward and backward motion value (e.g., a forward and backward optical flow value). Accordingly, if a given pixel has only a single motion value in both frames t and t+1, then the interpolated frame (at that pixel location) will use the motion value at either frame t or frame t+1. The use of occlusion masks is described in, for example, Herbst, Evan, Steve Seitz, and Simon Baker. “Occlusion reasoning for temporal interpolation using optical flow.” Department of Computer Science and Engineering, University of Washington, Tech. Rep. UW-CSE-09-08-019(2009), the contents of which are incorporated herein by reference in its entirety. In one exemplary implementation, each occlusion mask can be thought of as designating a logical occlusion mask value. In other words, in a given frame, each pixel will be denoted by either a logical ‘zero’ (e.g., indicating that the denoted pixel is occluded or not visible) or by a logical ‘one’ (e.g., indicating that the denoted pixel is not occluded and is in fact visible) with respect to another grouping (e.g., a superpixel grouping) in the image.

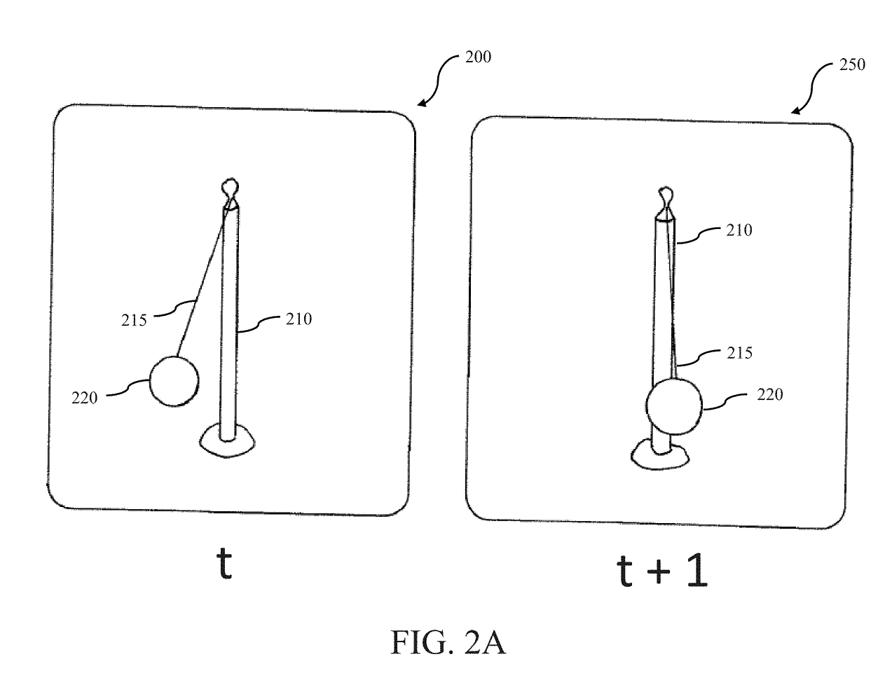

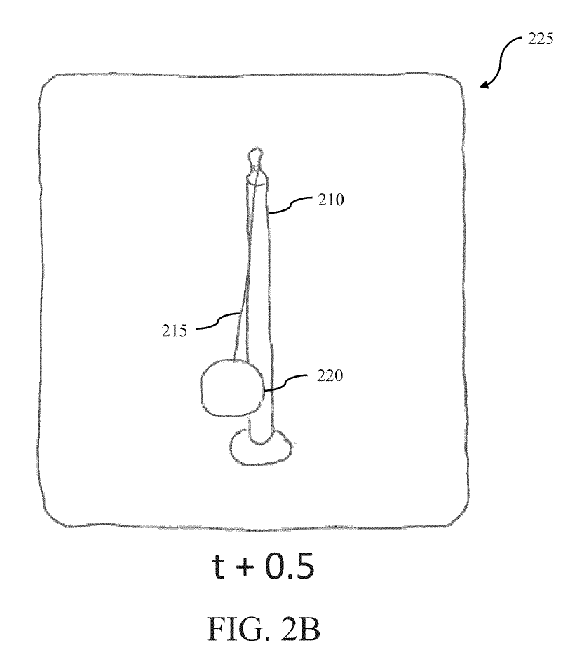

Moreover, with respect to a given image, a designated grouping for an object in the frame of data may possess multiple occlusion logical mask values. For example, and referring to the scene 250 depicted in frame t+1 (FIG. 2A), the tetherball pole 210 may be considered ‘occluding’ with respect to the background image. However, the tetherball pole 210, and specifically portions thereof, would be considered occluded by portions of the tetherball 220 itself. In other words, objects within a given scene may be given multiple differing occlusion mask logical values based on their relationship with other objects within the scene (including, without limitation, being both “masked” and “unmasked”). These and other variations would be readily apparent to one of ordinary skill given the contents of the present disclosure. The use of super pixel calculations is discussed within Achanta, Radhakrishna, et al. “SLIC superpixels compared to state-of-the-art superpixel methods.” IEEE transactions on pattern analysis and machine intelligence 34.11. (201.4 2274-2282; Xiao, Jianxiong, and Long Quan. “Multiple view semantic segmentation for street view images.” 2009 IEEE 12th international conference on computer vision. IEEE, 2009; and Schick, Alexander, Martin Bäuml, and Rainer Stiefelhagen. “Improving foreground segmentations with probabilistic superpixel markov random fields.” 2012 IEEE Computer Society Conference on Computer Vision and Pattern Recognition Workshops, IEEE, 2012, the contents of each of the foregoing being incorporated herein by reference in their entireties.

Referring to FIG. 2A, an exemplary case of the use of superpixels and its accompanying occlusion masks are described in additional detail. FIG. 2A illustrates two scenes of a tetherball 220, attached by a rope 215, swinging around a tetherball pole 210. In the scene depicted in frame t 200, the tetherball 220 is positioned to the left of the tetherball pole 210, while in the scene depicted in frame t+1 250, the tetherball 220 is now occluding a portion of the tetherball pole 210. During the superpixel calculation for these scenes, four groupings of pixels are generated. These groupings include the background of the scenes depicted in frame t and frame t+1; the tetherball pole 210; the tetherball string 215; and the tetherball 220, itself. Moreover, in the scene 250 depicted in frame t+1, it can be see that the tetherball 220 is occluding a portion of the tetherball pole 210. In addition, it can also be seen that the tetherball rope 215 is occluding portions of the tetherball pole 210 in both frame t and frame t+1. Furthermore, it can be seen that the tetherball 220, tetherball rope 215 and tetherball pole 210 each occlude the background grouping of pixels. Accordingly, the occlusion masks are generated based on these observations. While the prior discussion of superpixels is primarily discussed in the context of an object being associated with a given superpixel, it is appreciated that a given object may in fact contain multiple superpixels (i.e., two or more), with the aforementioned discussion merely being exemplary.

At step 108, the interpolated frame(s) of data are generated, and the interpolated frame(s) of data are down-sampled back to their original size. In one or more implementations, the interpolated frame of data is generated using a blending function associated with the pixels in the adjacent frames (i.e., those actual frames captured with the image capturing device). Blending can be utilized using a linear function (e.g., a weighted average between the colors in the adjacent frames) or a non-linear function (e.g., using a higher order function, or a distribution such as a Gaussian, Poisson, and the like). For example, these blending function calculations can be based on a linear interpolation calculation, a bilinear interpolation calculation, a cubic interpolation calculation and/or other known forms of interpolation calculation. More specifically, the interpolated frame(s) of data are generated based upon the calculations performed at steps 104 and 106. Exemplary blending functions are described in, for example, Xiong, Yingen, and Kari Pulli. “Gradient domain image blending and implementation on mobile devices.” International Conference on Mobile Computing, Applications, and Services. Springer Berlin Heidelberg, 2009; Gracias, Nuno, et al. “Fast image blending using watersheds and graph cuts,” Image and Vision Computing 27.5 (2009): 597-607; and Allène, Cédric, a Philippe Pons, and Renaud Keriven. “Seamless image-based texture atlases using multi-band blending.” Pattern Recognition, 2008. ICPR 2008. 19th international Conference on. IEEE, 2008, the contents of each of the foregoing being incorporated herein by reference in their entireties.

FIG. 2B illustrates an interpolated frame of data 225 for the scenes depicted in FIG. 2A. The interpolated scene in FIG. 2B illustrates the interpolated t+0.5 frame of data. This intermediate frame of data is generated based on the intermediate division of time desired using interpolation (e.g., blending) calculations of, for example, the RGB values obtained from frame ‘t’ and frame ‘t+1’ based on the intermediate pixel motion calculations performed at step 104.

However, using the occlusion masks calculated at step 106, it can be estimated that the tetherball 220 will occlude a portion of the tetherball pole 210 in the interpolated frame. Accordingly, by assigning the tetherball 220 a logical value (e.g., a logical value of ‘1’) indicating that this object should be considered occluding, and the tetherball pole 210 a logical value (e.g., a logical value of ‘0’) indicating that this object should be considered occluded with respect to the tetherball 220, the algorithm described herein will not blend. Rather, only the image values of the tetherball in frame t and frame t+1 will be considered in this portion of the interpolated frame. In other words, artifacts associated with the blending of pixels that result in, for example, the blurring of the interpolated image are minimized and/or removed. Moreover, the algorithm will only take into consideration lighting conditions, shading and other similar natural artifacts that are present in the tetherball at frame t and frame t+1, and will ignore the pixel values associated with the tetherball pole 210 in this occluded region.

### Usage Scenarios—

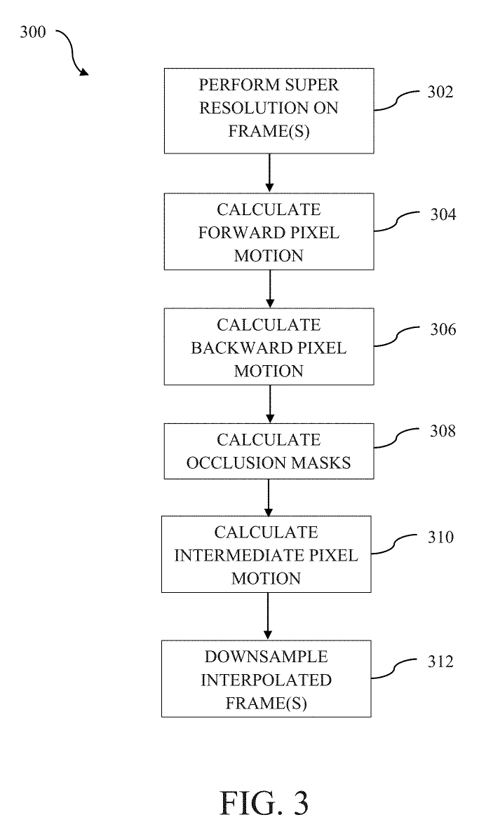

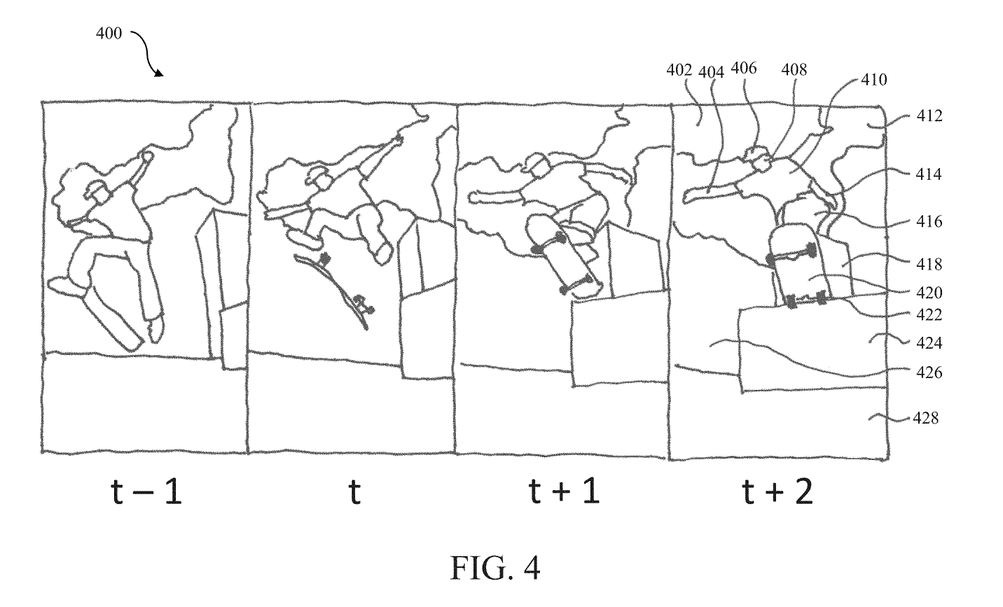

Referring now to FIG. 3, one exemplary method for generating interpolated frames of data useful for, for example, the series of frames of video data illustrated in FIG. 4, is shown and described in detail. At step 302, the method 300 first performs super resolution on the frame(s) of data. For example, in the exemplary context of generating an interpolated frame of data between times t and t+1 as illustrated in FIG. 4, super resolution is performed on frame t and frame t+1 (e.g., these frames of data are increased in size by a factor of two, three, four, or fractions thereof, etc.), by utilizing the information contained within, for example, frame t−1 and frame t+2, respectively. As previously discussed herein, the use of super resolution increases the size and resolution of the image by utilizing information in, for example, the previous and next images in a video sequence. In other words, super resolution frame t and super resolution frame t+1 are generated for subsequent processing steps.

At step 304, the forward pixel motion for each (or a portion) of the pixels is calculated from the initial frame (e.g., super resolution frame t) to the next frame (e.g., super resolution frame t+1), where t indicates a time step in the sequence of video images as previously described elsewhere herein.

At step 306, the backward pixel motion is calculated for each of the pixels from the next frame (e.g., super resolution frame t+1) to the previous frame (e.g., super resolution frame t). In the context of the two-dimensional series of images illustrated in FIG. 4, the calculation of the forward (at step 304) and backward (at step 306) pixel motions allows for the estimation of motion as either instantaneous image velocities or as discrete image displacements for every pixel in, for example, the two-dimensional images of FIG. 4.

At step 308, the occlusion masks for the series of images are calculated. For example at frame t, an occlusion mask is calculated for this frame that is denoted OM t, while at frame t+1, an occlusion mask is calculated for this frame that is denoted OM t+1. Note that each occlusion mask is, in the exemplary implementation, a so-called logical mask, meaning that each pixel would be denoted with either a ‘0’ (e.g., interpreted as not visible within a given frame) or a ‘1’ (e.g., interpreted as visible within a given frame). Although the use of a logical ‘1’ or logical ‘0’ is exemplary, it is appreciated that the precise numerology used in the assignment of logical masks can be readily modified by one or ordinary skill given the contents of the present disclosure.

As shown in frame t+2 in FIG. 4, one may readily observe that a portion of the cloud 412 is occluded by a number of objects, namely the skateboarder's right arm 404, the skateboarder's shirt 410, the skateboarder's left arm 414, the skateboarder's pants 416, the building 418, the skateboard 420 itself, as well as the upper left skateboard wheel 422. In other words, this portion of the cloud that is occluded would be marked with a ‘0’ indicating that this portion would not be visible in this interpolated frame. Accordingly, the pixel values associated with this occluded portion would not be utilized in generating the interpolated image.

The use of the concept of superpixels is instrumental in the creation of the intermediate pixel motion for the frames of data (calculated at step 310) and the occlusion masks (calculated at step 308). In order to remove or visually reduce the artifacts associated with an interpolated image, the concept of superpixels is used to cluster spatially similar items through, for example, similarities based on color, intensity and/or image gradients. In other words, the use of superpixels allows the post-processed interpolated images to treat each group of pixels (i.e., superpixels) as a single entity in the interpolation phase.

For example, returning again to frame t+2 in FIG. 4, one may imagine a number of superpixels that are determined. In addition to the aforementioned cloud 412, the skateboarder's right arm 404, the skateboarder's shirt 410, the skateboarder's left arm 414, the skateboarder's pants 416, the building 418, and the skateboard 420 itself, superpixel groupings may be generated for the skateboarder's face 408, the skateboarder's hat 406, the upper sky 402, the lower sky 426, the skating surface 428 and the curb 424 upon which the skateboarder is performing his trick. While specific objects have been described as belonging to a designated grouping, it is appreciated that the aforementioned example is merely intended to illustrate the broader principles of using superpixels, and is not intended to be limiting. For example, two or more of the aforementioned object groupings could conceivably be designated as a grouping in appropriate situations. Alternatively, each of the aforementioned object groupings may be divided into a number (e.g., two or more) designated superpixel groupings. The use of superpixels reduces the ambiguity associated with various objects depicted within the scene by associating, and distinguishing, whether a given pixel in the scene is associated with, for example, the person performing the skateboarding trick or associated with other pixels in the background of the image.

At step 310, the intermediate pixel motion is calculated based on an alpha, where alpha is the intermediate division of time. For example, where the intermediate division of time is a half-step (i.e., t+0.5), the value of alpha will be equal to 0.5. As yet another example, where the intermediate division of time is a tenth of a step (i.e., t+0.1), the value of alpha will be equal to 0.1. As yet another example, where the intermediate division of time is nine tenths of a step (i.e., t+0.9), the value of alpha will be equal to 0.9. These and other intermediate divisions of time would be readily apparent to one of ordinary skill given the contents of the present disclosure.

Additionally, the intermediate pixel motion calculation utilizes the occlusion masks calculated at step 308 in order to determine whether groupings of pixels would either be visible or not visible. For example, in frame t+1 and frame t+2 in FIG. 4, it can be seen that the skateboard 420 is partially occluding the building 418. Accordingly, when an interpolated image is generated between frames t+1 and t+2, the concept of super pixels allows the occluded portion of the building 418 to be removed for the purposes of the interpolation calculation. In other words, when the interpolated image is created, the interpolation algorithm chosen can ignore the pixel values associated with the building 418, leading to a crisper and less-transparent interpolated image in this portion of the image in which the building 418 is occluded. Similarly, the portion of the cloud that is occluded by the skateboarder's pants 416, the skateboarder's shirt 410 and the skateboarder's arms 404, 414 would also be determined to be occluded, thereby leading to a crisper and less-transparent interpolated pixels in this portion of the image as the cloud 412 in these portions of the image will be determined to be occluded during the interpolation calculation.

The interpolated super resolution frame is created based on the aforementioned alpha by using, for example, a linear interpolation, a bilinear interpolation, a cubic interpolation or other known mathematical interpolation technique of, for example, the RGB values obtained from frame t and frame t+1 based on the intermediate pixel motion and the occlusion masks. For example, where linear interpolation is utilized, the interpolated value of a given pixel is determined by connecting two adjacent known values depicted in the preceding and subsequent frames, respectively. Moreover, where a grouping of pixels is determined to be occluded, these pixel values (e.g., RGB pixel values) are not utilized in determining the values for these pixels in the interpolated image. Where bilinear interpolation is used, the interpolated value of a given pixel is determined by, for example, performing linear interpolation on a first axis of a two-dimensional grid (e.g., the x-axis) and subsequently performing linear interpolation on a second axis of a two-dimensional grid (e.g., the y-axis). Again, where a grouping of pixels is determined to be occluded, these pixel values for the occluded portion of the picture are not utilized in determining the values for these pixels in the interpolated image.

At step 312, the interpolated super resolution frame is down-sampled to create the final interpolated frame(s). In other words, the interpolated super resolution frame is down-sampled back to its native resolution. Accordingly, by using the concepts of super resolution, artifacts associated with the interpolated image (i.e., blurred lines, non-smooth or non-sharp lines) are minimized, while the use of superpixels minimizes undesirable artifacts such as ghosting, lines becoming waves, and connected components becoming disconnected, thereby resulting in a cleaner interpolated image with reduced spatial and temporal artifacts.

### Exemplary Apparatus—

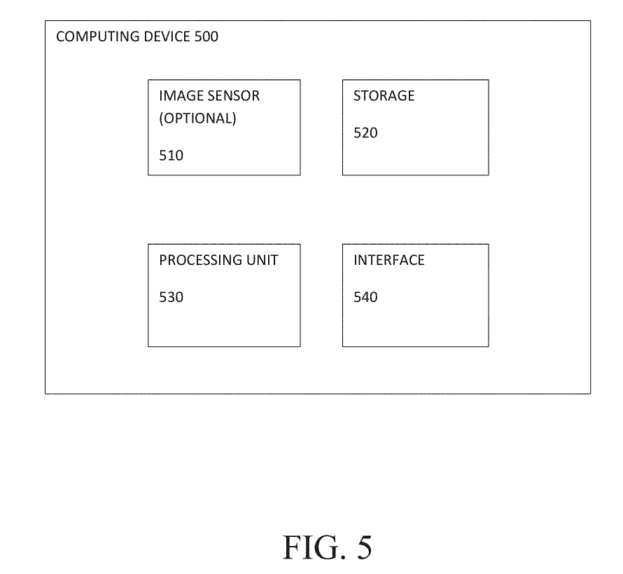

FIG. 5 is a block diagram illustrating an embodiment of a computing device, in accordance with the principles described herein. The computing device 500 of the embodiment of FIG. 5 includes an optional image sensor 510, a storage module 520, a processing unit 530, and an interface module 540. The various components of the computing device 500 are communicatively coupled, for instance via a communications bus not illustrated herein, thereby enabling communication between the various ones of the components.

The image sensor 510 is configured to convert light incident upon the image sensor chip into electrical signals representative of the light incident upon the image sensor. Such a process is referred to as “capturing” image or video data, and capturing image data representative of an image is referred to as “capturing an image” or “capturing a frame”. The image sensor can be configured to capture images at one or more frame rates, and can be configured to capture an image in a first interval of time and then wait a second interval of time before capturing another image (during which no image data is captured). The image sensor can include a charge-coupled device (“CCD”) image sensor, a complementary metal-oxide semiconductor (“CMOS”) image sensor, or any other suitable image sensor configured to convert captured light incident upon the image sensor chip into image data. Moreover, while the image sensor 510 is illustrated as forming part of the computing device 500, it is appreciated that in one or more other implementations, image sensor 510 may be located remote from computing device 510 and instead, images captured via the image sensor may be communicated to the computing device via the interface module 540.

The methodologies described herein, as well as the operation of the various components of the computing device can be controlled by the processing unit 530. In one embodiment, the processing unit is embodied within one or more integrated circuits and includes a processor and a memory comprising a non-transitory computer-readable storage medium storing computer-executable program instructions for performing the image post-processing methodologies described herein, among other functions. In such an embodiment, the processor can execute the computer-executable program instructions to perform these functions. It should be noted that the processing unit can implement the image post-processing methodologies described herein in hardware, firmware, or a combination of hardware, firmware, and/or software. In some embodiments, the storage module 520 stores the computer-executable program instructions for performing the functions described herein for execution by the processing unit 530.

The storage module 520 includes a non-transitory computer-readable storage medium configured to store data. The storage module can include any suitable type of storage, such as random-access memory, solid state memory, a hard disk drive, buffer memory, and the like. The storage module can store image data captured by the image sensor 510. In addition, the storage module can store a computer program or software useful in performing the post-processing methodologies described herein with reference to FIGS. 1 and 3 utilizing the image or video data captured by image sensor 510.

The interface module 540 allows a user of the computing device to perform the various processing steps associated with the methodologies described herein. For example, the interface module 540 can allow a user of the computing device to begin or end capturing images or video, can allow a user to perform the super resolution calculations as well as perform the forward and backward pixel motion calculations. Additionally, the interface module 540 can allow a user to perform the superpixel calculations on the video data as well as calculate the occlusion masks associated with this video data. Additionally, the interface module 540 can allow a user to generate interpolated frame(s) of data as well as receive image or video data from a remote image sensor. Moreover, the interface module 540 optionally includes a display in order to, inter alia, display the interpolated frame(s) of data and the captured frame(s) of data.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “computing device”, includes, but is not limited to, personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “camera” may be used to refer to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A computerized apparatus configured to generate interpolated frames of video data, the apparatus comprising:
a video data interface configured to receive a plurality of frames of video data, each of the frames of video data having a native resolution;
a processing apparatus in data communication with the video data interface; and
a storage apparatus in data communication with the processing apparatus, the storage apparatus having a non-transitory computer readable medium comprising instructions which are configured to, when executed by the processing apparatus, cause the computerized apparatus to:
receive an initial frame and a subsequent frame of video data from the received plurality of frames of video data;
perform a super resolution calculation on the initial frame and the subsequent frame of video data so that to obtain at least a super resolution initial frame and a super resolution subsequent frame;
perform a superpixel calculation on at least the super resolution initial frame and the super resolution subsequent frame;
obtain an interpolated super resolution frame of data; and
downsample the interpolated super resolution frame of data back to the native resolution in order to obtain an interpolated frame of data.

2. The computerized apparatus of claim 1, wherein:
the instructions are further configured to, when executed by the processing apparatus, cause the computerized apparatus to obtain an occlusion mask based at least in part on the performed superpixel calculation; and
the generation of the interpolated super resolution frame of data is based at least in part on the obtained occlusion mask.

3. The computerized apparatus of claim 2, wherein the instructions are further configured to, when executed by the processing apparatus, cause the computerized apparatus to:
calculate a forward motion interpolation from the super resolution initial frame to the super resolution subsequent frame; and
calculate a backward motion interpolation from the super resolution subsequent frame to the super resolution initial frame.

4. The computerized apparatus of claim 3, wherein the instructions are further configured to, when executed by the processing apparatus, cause the computerized apparatus to calculate an intermediate pixel motion frame for an intermediate division of time between the initial frame and the subsequent frame.

5. The computerized apparatus of claim 4, wherein the intermediate division of time is selected from one of a plurality of discrete instances of time between the initial frame and the subsequent frame.

6. The computerized apparatus of claim 4, wherein the generation of the occlusion mask is indicative of a set of pixels being occluded in at least one of the initial frame and the subsequent frame.

7. The computerized apparatus of claim 6, wherein the instructions are further configured to, when executed, cause the computerized apparatus to determine that the set of pixels is occluded in the interpolated frame of data, the determination based at least in part on the calculated intermediate pixel motion and the obtained occlusion mask; and
based at least on the determination of occlusion, ignore one or more values associated with the set of pixels during the generation of the interpolated super resolution frame of data.

8. The computerized apparatus of claim 7, wherein the obtained interpolated super resolution frame of data is obtained at least in part upon an interpolation calculation.

9. The computerized apparatus of claim 8, wherein the interpolation calculation comprises one or more of: (i) a linear interpolation algorithm, and (ii) a non-linear algorithm.

10. The computerized apparatus of claim 1, wherein the performance of the super resolution calculation on the initial frame utilizes both a preceding frame for the initial frame and the initial frame; and
wherein the performance of the super resolution calculation on the subsequent frame utilizes both the subsequent frame for the frame and a frame that occurs temporally after the subsequent frame.

11. A method of generating interpolated frames of video data, comprising:
causing the performance of a super resolution calculation on an initial and one or more subsequent frames of video data in order to produce at least a super resolution initial frame and a super resolution subsequent frame;
causing the performance of a superpixel calculation on the super resolution initial frame and the super resolution subsequent frame;
causing the obtainment of an occlusion mask based at least in part on the performed superpixel calculation;
causing the obtainment of an interpolated super resolution frame of data based at least in part on the obtained occlusion mask; and
causing the downsampling of the interpolated super resolution frame of data back to a native resolution in order to obtain an interpolated frame of data.

12. The method of claim 10, further comprising:
causing the calculation of a forward pixel motion from the super resolution initial frame to the super resolution subsequent frame; and
causing the calculation of a backward pixel motion from the super resolution subsequent frame to the super resolution initial frame.

13. The method of claim 11, further comprising:
causing the calculation of an intermediate pixel frame between the initial frame and the one or more subsequent frames of video data.

14. The method of claim 12, further comprising:
enabling the selection of one of a plurality of intermediate divisions of time;
wherein the selected one of the plurality of intermediate divisions of time is utilized at least in part for the calculated intermediate pixel motion.

15. The method of claim 13, further comprising:
causing a determination that a set of pixels is occluded in the interpolated super resolution frame of data based at least in part on determining the set of pixels is occluded in either the initial frame of video data or the subsequent frame of video data.

16. The method of claim 14, further comprising:
ignoring one or more values associated with the set of pixels during the generation of the interpolated super resolution frame of data.

17. A computing device, comprising:
logic configured to:
receive an initial and subsequent frame of video data from a plurality of captured frames of video data;
perform a super resolution calculation on the initial and subsequent frames of video data in order to produce a super resolution initial frame and a super resolution subsequent frame;
obtain an occlusion mask based at least in part on a performed superpixel calculation;
obtain an interpolated super resolution frame of data based at least in part on the obtained occlusion mask; and
downsample the interpolated super resolution frame of data back to a native resolution in order to obtain an interpolated frame of data.

18. The computing device of claim 16, further comprising an image sensor, the image sensor configured to capture the plurality of captured frames of video data.

19. The computing device of claim 16, further comprising an interface module, the interface module comprising a display that is configured to display the interpolated frame of data.

20. The computing device of claim 19, wherein:
the interface module comprises a user interface, the user interface configured to receive a plurality of commands from a user in order to perform the super resolution calculation and a superpixel calculation; and the superpixel calculation is configured to be performed subsequent to the super resolution calculation.
